(19) United States
(12) Patent Application Publication
(10) Pub. No.: US 2006/0114764 A1
(43) Pub. Date: Jun. 1, 2006

(54) Birefringent optical component

(76) Inventor: Emile Johannes Karel Verstegen, Eindoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/540,799

(22) PCT Filed: Dec. 10, 2003
(86) PCT No.: PCT/IB03/05970

§ 371 Date: Jun. 27, 2005

(30) Foreign Application Priority Data
Dec. 30, 2002 (EP) 02080548.7

(51) Int. Cl. G11B 7/00

(52) U.S. Cl. 369/44.11; 369/112.01

(57) ABSTRACT

An optical component (600, 181) comprises two adjacent materials (610, 620) with a shaped (e.g. curved) interface between the materials (612, 622). The first of the materials (610) is birefringent. The second material (620) has a refractive index substantially equal to the refractive index of the birefringent material at a predetermined angle.

### FIELD OF THE INVENTION

The present invention relates to optical components comprising a birefringent material, devices including such components and methods of manufacturing such components and devices. The component is particularly suitable for but not limited to, use as an optical element in optical scanning devices.

### BACKGROUND OF THE INVENTION

Optical pickup units for use in optical scanning devices are known. The optical pickup units are mounted on a movable support for scanning across the tracks of the optical disk. The size and complexity of the optical pickup unit is preferably reduced as much as practicable, in order to reduce the manufacturing cost and to allow additional space for other components being mounted in the scanning device.

Modern optical pickup units are generally compatible with at least two different formats of optical disk, such as the Compact Disc (CD) and the Digital Versatile Disc (DVD) format. Recently proposed has been the Blu-ray Disk (BD) format, offering a data storage capacity of around 25 GB (compared with a 650 MB capacity of a CD, and a 4.7 GB capacity of a DVD).

Larger capacity storage is enabled by using small scanning wavelengths and large numerical apertures (NA), to provide small focal spots, (the size of the focal spot is approximately λ/NA), so as to allow the readout of smaller sized marks in the information layer of the disk. For instance, a typical CD format utilises a wavelength of 785 nm and has an objective lens with a numerical aperture of 0.45, a DVD uses a wavelength of 650 nm and has a numerical aperture of 0.65, and a BD system uses a wavelength of 405 nm and a numerical aperture of 0.85.

Typically, the refractive index of materials vary as a function of wavelength. Consequently, a lens will provide different focal points and different performance for different incident wavelengths. Further, the discs may have different thickness transparent layers, thus requiring a different focal point for different types of discs.

In some instances, storage capacity is further increased by increasing the number of information layers per disc. For example, a dual layer BD-disc has two information layers separated by a 25 μm thick spacer layer. Thus, the light from the optical pickup unit has to travel through the spacer layer when focusing on the second information layer. This introduces spherical aberration, the phenomenon that rays close to the axis of the converging cone of light have a different focal point compared to the rays on the outside of the cone. This results in a blurring of the focal spot, and a subsequent loss of fidelity in the read-out of the disc.

To enable dual layer readout and backward compatibility (i.e. the same optical system being used for different disc formats), polarisation sensitive lenses (PS-Lenses) have been proposed to compensate for spherical aberration. Such lenses can be formed of a birefringent material, such as a liquid crystal. Birefringence denotes the presence of different refractive indices for the two polarisation components of a beam of light. Birefringent materials have an extraordinary refractive index (nₑ) and an ordinary refractive index (nₒ), with the difference between the refractive indices being Δn≈nₑ31 nₒ. PS lenses can be used to provide different focal points for a single or different wavelengths by ensuring that the same or different wavelength(s) are incident upon the lens with different polarisations.

It is an aim of embodiments of the present invention to provide an improved optical component which addresses one or more of the problems of the prior art, whether referred to herein or otherwise.

It is an aim of particular embodiments of the present invention to provide a birefringent lens that can be switched to a neutral state such that it does not alter the direction of incident light, as well as a method of manufacturing such a lens.

### STATEMENTS OF THE INVENTION

In a first aspect, the present invention provides an optical scanning device for scanning an information layer of an optical record carrier, the device comprising a radiation source for generating a radiation beam, and an objective system for converging the radiation beam on the information layer, wherein the device includes an optical element comprising at least two adjacent materials with a shaped interface between the materials, at least the first of the materials being birefringent, the second material having a refractive index substantially equal to the refractive index of the birefringent material at a predetermined angle.

By providing an element having two such materials, the optical function defined by the interface can effectively be switched to a neutral state. For instance, if the interface is curved, the lens capability of the interface can be switched so as not to provide any focussing or dispersing effect by ensuring that a polarised beam of radiation is incident upon the element with the correct orientation. This permits the simplification of the optical arrangement within a scanning device. Further, the second material can act to protect, at least in part, the birefringent material.

In another aspect, the present invention provides an optical component comprising at least two adjacent materials with a shaped interface between the materials, at least the first of the materials being birefringent, the second material having a refractive index substantially equal to the refractive index of the birefringent material at a predetermined angle.

In a further aspect, the present invention provides a method of manufacturing an optical scanning device for scanning an information layer of an optical record carrier, the information layer being covered by a transparent layer of thickness t_{d} and refractive index n_{d}, the method comprising the steps of: providing a radiation source for generating a radiation beam; providing an optical element, the optical element comprising at least two adjacent materials with a shaped interface between the materials, at least the first of the materials being birefringent, the second material having a refractive index substantially equal to the refractive index of the birefringent material at a predetermined angle.

In another aspect, the present invention provides a method of manufacturing an optical component, the method comprising: providing at least two adjacent materials with a shaped interface between the materials, at least the first material being birefringent and the second material having a refractive index substantially equal to one of the refractive indices of the birefringent material at a predetermined angle.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 illustrates an optical component in accordance with a preferred embodiment of the present invention;

FIGS. 2A-2H illustrate method steps in the formation of a liquid crystal lens in accordance with a preferred embodiment of the present invention;

FIG. 3 illustrates a device for scanning an optical record carrier including a liquid crystal lens in accordance with an embodiment of the present invention;

FIGS. 4A and 4B illustrate how the optical system of the scanning device shown in FIG. 3 may be used with different polarisations of light to scan different layers within a dual layer optical record carrier, and

FIG. 5 illustrates an optical component in accordance with a further 5 embodiment of the present invention.

### DETAILED DESCRIPTION OF PREFERRED EMBODIMENTS

Optical components (or portions of optical components, optical elements) can include curved surfaces so as to focus light (e.g. a convex lens) or disperse light (e.g. a concave lens). Birefringent optical components with curved surfaces will provide different focussing or dispersive effects, dependent upon the angle at which the polarised radiation beam is incident on the optical component.

Equally, optical functions of other components are provided by other shaped (i.e. non-planar) surfaces such as step functions and gratings.

The present inventor has realised that, by providing an additional material adjacent to the curved (or otherwise shaped) surface, with the additional material having a refractive index substantially equal to the refractive index of the birefringent material at a predetermined angle, then when polarised light is incident on the surface (i.e. the interface between the birefringent material and the additional material) at this predetermined angle, the surface will have a neutral effect (e.g. it will not act to focus or disperse the light) due to the index matching.

Consequently, for differently shaped surfaces, such as step structures and gratings, the optical function of the components can be switched on and off by setting the incident polarisation such that it leads to a substantially equal refractive index match between the two adjacent materials, so that the interface between the two materials becomes invisible.

In inorganic birefringent materials (e.g. a crystal such as calcite) the atomic structure is non-symmetric. This leads to an anisotropy in the physical constants of materials in different directions. One of those is the refractive index. Consider a polarised beam of light traversing along different optical axis. There will be one optical axis in which a different refractive index will be observed upon traversion perpendicularly and parallel to the optical axis. In general, but not always, two out of three axes have a refractive index that is higher than the refractive index of the third axis.

In organic crystals, such as a liquid crystal, a similar phenomenon occurs although one can of course not talk about a difference in the atomic structure but only of orientational order within the liquid that resembles a crystal structure. Generally, although not always, two out of three axes have a refractive index that is lower than in the third axis.

The direction in which the molecules of a liquid crystal are aligned is called the director. Light propagating with its plane of polarisation parallel to the director experiences the extraordinary refractive index, nₑ.

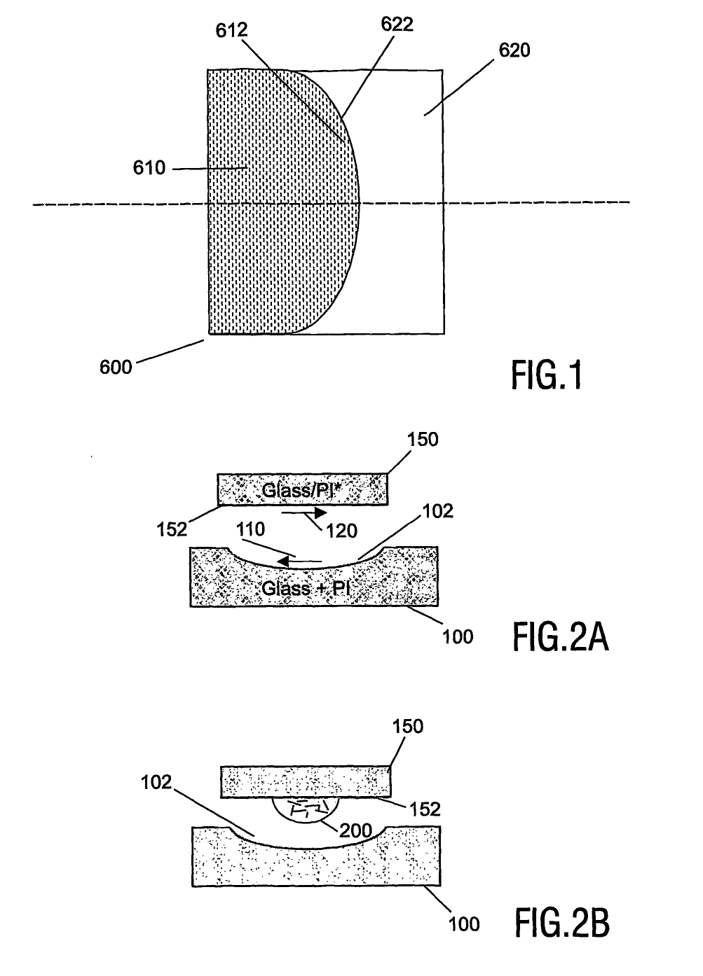

FIG. 1 illustrates an optical component 600 in accordance with a preferred embodiment of the present invention. The optical component 600 can be envisaged as being formed of two portions. The first portion is a planoconvex lens 610 formed of birefringent material. Since the birefringent material is made of a typical liquid crystal, it has two ordinary axes yielding an ordinary refractive index nₒ and one extraordinary axis yielding a refractive index nₑ. The second portion of the component comprises a planoconcave lens 620. In this embodiment, the planoconcave lens is formed of a material having a uniform refractive index nₛ, where nₑ≧nₛ≧nₒ. In this particular embodiment, nₛ=nₒ. The extraordinary axis of the birefringent material is perpendicular to the normal of the component.

The curved interface between the two portions corresponds to the convex surface 612 of the planoconvex lens 610 mating with the concave surface 622 of the concave lens 620.

It will be appreciated that, when the polarised light is incident upon the optical component 600 along the ordinary axis of the birefringent material with its plane of polarisation perpendicular to the director, then as nₒ=nₛ, the light will not experience any lens effects i.e. the component will act as an optically neutral component.

However, when the plane of polarisation of the polarised light incident upon the optical component 600 is no longer perpendicular to the director, the refractive index of the planoconvex 610 portion will be greater than the refractive index of the planoconcave portion 620. This is valid only for the plane of polarisation projected onto the extraordinary axis of the birefringent material, such that for this projected polarisation a lens effect is realised by the light i.e. the light is focused. For the plane of polarisation projected onto the ordinary axis of the birefringent material no refractive index transition is observed.

Since the plane of polarisation is projected onto two axes, two individual lens effects will be realised, which if desired can be made visible separately using a polariser.

When the plane of polarisation is exactly parallel to the director and the angle of incidence is exactly parallel to the normal of the optical component, there is no projection of the plane of polarisation onto the ordinary axis and thus only the nₑ is experienced for the birefringent material. Maximum light intensity is then achieved in one single spot, so the light is focused.

In another case where the component is tilted at an angle θ with respect to the normal of the component, but without twist, such that the plane of polarisation intersects with the extraordinary axis of the birefringent material, a refractive index n_{θ} is observed according to the formula:

$${n}_{θ} = \frac{{n}_{o} {n}_{e}}{\sqrt{{n}_{e}^{2} {sin}^{2} θ + {n}_{o}^{2} {cos}^{2} θ}}$$

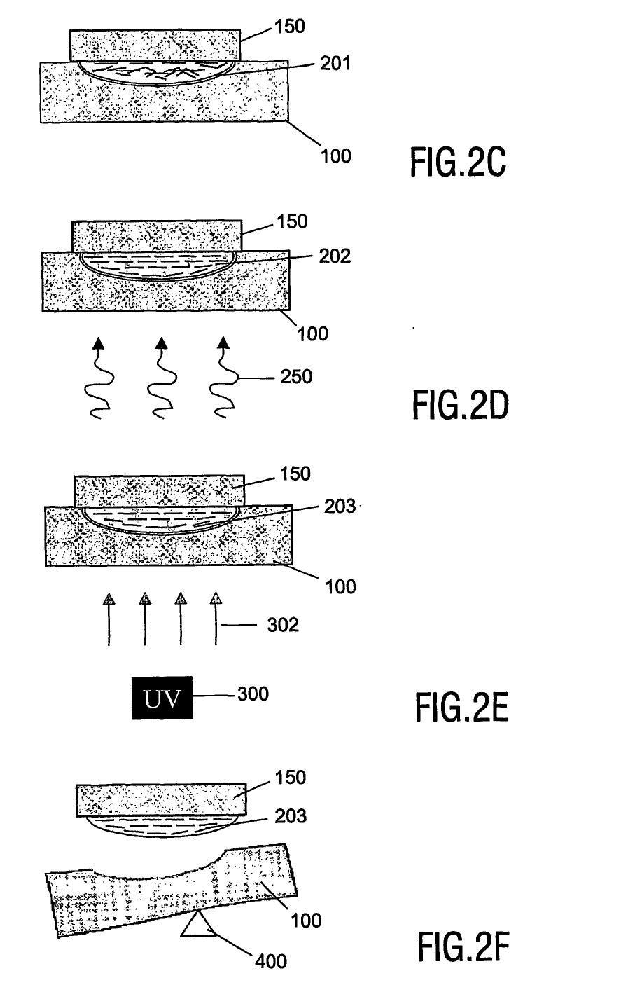

FIGS. 2A-2H illustrate respective steps in forming an optical component in accordance with a preferred embodiment of the present invention. In this particular instance, the optical component includes a liquid crystal birefringent lens.

In the first step, shown in FIG. 2A, mould 100 is provided, the mould having a shaped surface 102 which subsequently serves to define a portion of the shape of the resulting optical component. In this particular instance, the liquid crystal is ultimately photopolymerised, and consequently the mould is formed of a material transparent to the radiation used to polymerise the liquid crystal e.g. glass.

An alignment layer 110 is arranged on the curved surface 102, so as to induce a predetermined orientation (indicated by the arrow direction 110) in the liquid crystal subsequently placed upon the alignment layer.

In this particular example, the alignment layer is a layer of polyimide (PI). The polyimide may be applied using spincoating from a solution. The polyimide may then be aligned so as to induce a specific orientation (this orientation determining the resulting orientation of the liquid crystal molecules). For instance, a known process is to rub the polyimide layer with a non-fluff cloth repeatedly in a single direction so as to induce this orientation (110).

A substrate 150, which in this particular embodiment will form part of the optical component, has a bonding layer 120 applied to a first surface 152. The bonding layer is arranged to form a bond with the liquid crystal. In this particular instance, the bonding layer is also an alignment (or orientation) layer comprising polyimide. The bonding layer contains reactive groups arranged to form a chemical bond with the liquid crystal molecules, and in this instance has the same type of reactive group as the liquid crystal molecules, such that when photopolymerising the liquid crystal molecules, chemical bonds with the bonding layer on the substrate are also created. This results in very good adhesion between substrate and the liquid crystal layer. The bonding layer may be deposited on the substrate using the same type of process used to deposit and align the alignment layer on the mould 100. The bonding layer, which in this instance also functions as an alignment layer, is oriented in a predetermined orientation (arrow 120) depending upon the desired properties of the resulting liquid crystal components.

The bonding layer is aligned so as to be parallel to the direction 110 of the alignment layer on the mould. Preferably, the orientation of the bonding layer is parallel but in the opposite direction to the orientation of the alignment layer.

As illustrated in FIG. 2B, a compound 200 incorporating one or more liquid crystals is then placed between the first surface 152 of the substrate 150 and the shaped surface 102 of the mould 100.

In this particular example, as illustrated in FIG. 2B, the compound 200 comprises a mixture of two different liquid crystals. These two different liquid crystals have been chosen so as to provide the desired refractive index properties once at least one of the liquid crystals has been polymerised.

A droplet of the liquid crystals 200 is placed on the first surface 152 of the substrate. The compound 200 has been degassed, so as to avoid the inclusion of air bubbles within the resulting optical component. It also avoids the formation of air bubbles from dissolved gases coming out of the solidifying liquid during polymerisation, as the shrinkage during polymerisation leads to a large pressure decrease inside the polymerising liquid.

The glass mould is then heated so that the liquid crystal is in the isotropic phase (typically to about 80° C.), so as to facilitate the subsequent flow of the liquid crystal into the desired shape.

The substrate and the mould are subsequently brought together, so as to define the shape of the liquid crystal portion 201 of the final resulting optical component (FIG. 2C). In order to ensure that the liquid crystal forms a homogenous layer between the mould and the substrate, a pressure may be applied to push the substrate towards the mould (or vice versa).

The substrate/mould/liquid crystal may then be cooled, for instance down to room temperature for 30 minutes, so as to ensure that the liquid crystal enters the nematic phase, coming from the isotropic phase.

When entering the nematic stage, multi domains may appear in the liquid crystal mixture. Consequently, the mixture can be heated to above the clearing point to destroy the multidomain orientation (e.g. the mixture may be heated for 3 minutes to 105° C.). Subsequently, the mixture may be cooled to obtain a homogenous orientation 202 (FIG. 2D).

The homogenous liquid crystal mixture may then be photopolymerised using light 302 from an ultra violet radiation source 300 (FIG. 2E), for instance by applying a UV-light intensity of 10 W/cm² for 60 seconds. At the same time, chemical bonds will be formed between the liquid crystal and the bonding layer.

Subsequently, the first element (or portion) of the optical component (150, 203) can be released from the mould 100 (FIG. 2F). This could, for instance, be achieved by slightly bending the mould 100 over a cornered object 400. Alternatively, it could be achieved by pressing a portion of the flat substrate in a flat support, so as to slightly bend the flat substrate. The liquid crystal/substrate element should separate easily from the mould, as a conventional polyimide (without reactive groups) is used on the mould.

The mould can be reused to produce subsequent elements of components, by repeating steps illustrated in FIGS. 2B-2F. Typically, the alignment layer will remain upon the mould 100, and hence does not need to be reapplied.

If desired, a further processing step can be performed to remove the liquid crystal 202 from the substrate 150. However, in most instances it is assumed that the substrate 150 will form part of the final optical component.

FIGS. 2G and 2H illustrate the processing steps that can be used to provide the second material to the optical element formed by steps 2A-2F, so as to result in the final optical component.

A second substrate 160 is provided with a liquid substance that can be turned into a transparent solid with the desired refractive index e.g. a curable monomer 162. Spacers 170 are placed on top of the first substrate 150 (i.e. on the same side of the substrate as the polymerised birefringent element 203). The spacer act to define the gap between the surface of the liquid crystal and the flat surface of the polymerised monomer layer. These spacers could also act to define the length of the final optical component. In this particular example, the final optical component has a length equal to the width of substrate 150, the width of substrate 160, and the height of the spacers 170.

The curable monomer 162 has been selected such that the refractive index of the monomer after curing will be substantially equal to the ordinary refractive index of the polymerised birefringent material 203.

The second substrate 160 can be formed of a transparent material, such as glass. The spacers can be formed of any desired material, for instance glass or foil.

As shown in FIG. 2H, the second substrate 160 is placed upon the spacers 170, so as to sandwich the curable monomer 162 from FIG. 2G between the two substrates 150, 160. The monomer will then fill the gap between the two substrates.

Subsequently, the monomer 162 is cured to form the polymer 164 by applying UV radiation 302 from a UV radiation source 300.

Subsequently, if desired, either or both of the substrates 150, 160 may be removed.

The result is an optical component, generally similar to that illustrated in FIG. 1.

A suitable polyimide for use in the alignment layer is OPTMER AL-1051 supplied by Japan Synthetic Rubber Co., whilst Merck ZLI2650, spincoated from a solution in γ-butyrolactone can be used as an appropriate reactive polyimide with methacrylate groups as the bonding layer.

As mentioned above, in the preferred embodiment a mixture of two liquid crystals was utilised to obtain the desired nₑ and nₒ. The two liquid crystals utilised were 1,4-di(4-(3-acryloyloxypropyloxy)benzoyloxy)-2-methylbenzene (RM 257) and E7 (a cyanobiphenyl mixture with a small portion of cyanotriphenyl compound) both from Merck, Darmstadt, Germany. The photoinitiator used to ensure the photo polymerisation of both the liquid crystals and the curable monomer was Irgacure 651, obtainable from Ciba Geigy, Basel, Switzerland The curable monomer used was 2,2-di(4-(2-methacryloyloxyethyloxy)phenoxy)-propane (Diacryl 101) from Akzo Nobel, Arnhem, The Netherlands.

In some instances, a surfactant was mixed with the liquid crystal to promote the lens release from the mould. The surfactants utilised were FC171 a perfluorinated surfactant (3M) and 2-(N-ethylperfluorooctane sulfonamido-ethylacrylate (Acros). The use of the surfactant was seen to influence the orientation of the liquid crystal (a lower Δn was seen when a surfactant was utilised).

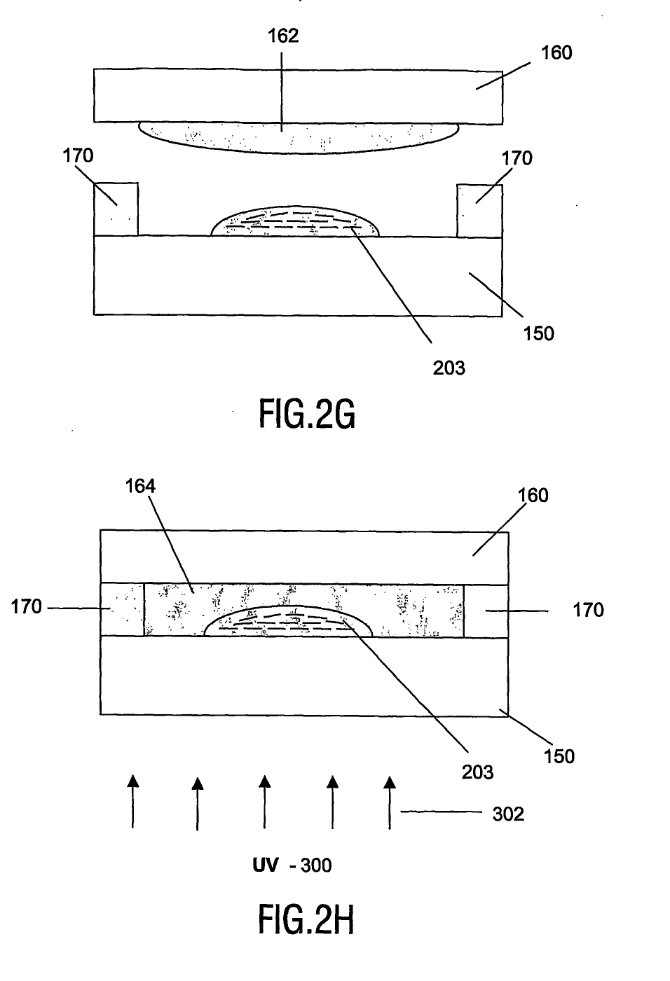

FIG. 3 shows a device 1 for scanning an optical record carrier 2, including an objective lens 18 according to an embodiment of the present invention. The record carrier comprises a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 acts as a substrate for the record carrier by providing mechanical support for the information layer.

Alternatively, the transparent layer may have the sole function of protecting the information layer, while the mechanical support is provided by a layer on the other side of the information layer, for instance by the protection layer 5 or by a further information layer and a transparent layer connected to the information layer 4. Information may be stored in the information layer 4 of the record carrier in the form of optically detectable marks arranged in substantially parallel, concentric or spiral tracks, not indicated in the Figure. The marks may be in any optically readable form, e.g. in the form of pits, or areas with a reflection coefficient or a direction of magnetisation different from their surroundings, or a combination of these forms.

The scanning device 1 comprises a radiation source 11 that can emit a radiation beam 12. The radiation source may be a semiconductor laser. A beam splitter 13 reflects the diverging radiation beam 12 towards a collimator lens 14, which converts the diverging beam 12 into a collimated beam 15. The collimated beam 15 is incident on an objective system 18.

The objective system may comprise one or more lenses and/or a grating. The objective system 18 has an optical axis 19. The objective system 18 changes the beam 17 to a converging beam 20, incident on the entrance face 6 of the record carrier 2. The objective system has a spherical aberration correction adapted for passage of the radiation beam through the thickness of the transparent layer 3. The converging beam 20 forms a spot 21 on the information layer 4. Radiation reflected by the information layer 4 forms a diverging beam 22, transformed into a substantially collimated beam 23 by the objective system 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26. A signal processor 27 converts these output signals to various other signals.

One of the signals is an information signal 28, the value of which represents information read from the information layer 4. The information signal is processed by an information processing unit for error correction 29. Other signals from the signal processor 27 are the focus error signal and radial error signal 30. The focus error signal represents the axial difference in height between the spot 21 and the information layer 4. The radial error signal represents the distance in the plane of the information layer 4 between the spot 21 and the centre of a track in the information layer to be followed by the spot.

The focus error signal and the radial error signal are fed into a servo circuit 31, which converts these signals to servo control signals 32 for controlling a focus actuator and a radial actuator respectively. The actuators are not shown in the Figure. The focus actuator controls the position of the objective system 18 in the focus direction 33, thereby controlling the actual position of the spot 21 such that it coincides substantially with the plane of the information layer 4. The radial actuator controls the position of the objective lens 18 in a radial direction 34, thereby controlling the radial position of the spot 21 such that it coincides substantially with the central line of track to be followed in the information layer 4. The tracks in the Figure run in a direction perpendicular to the plane of the Figure.

The device of FIG. 3 in this particular embodiment is adapted to scan also a second type of record carrier having a thicker transparent layer than the record carrier 2. The device may use the radiation beam 12 or a radiation beam having a different wavelength for scanning the record carrier of the second type. The NA of this radiation beam may be adapted to the type of record carrier. The spherical aberration compensation of the objective system must be adapted accordingly.

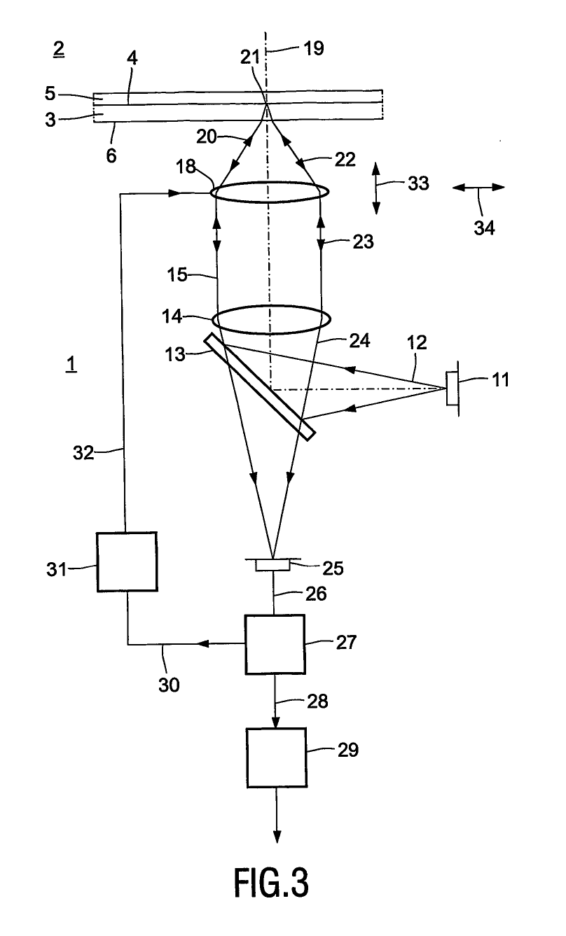

FIGS. 4A and 4B illustrate how the polarisation sensitive lens manufactured in accordance with the above embodiment can be utilised to provide two different focal points, suitable for reading a dual-layer optical recording medium 2′. The dual-layer medium 2′ has two information layers (4, 4′), a first information layer 4 at a depth d within the transparent layer 3, and a second information layer 4′ a further distance Δd beneath the first information layer 4.

In the embodiment shown in FIGS. 4A and 4B, the objective system 18 comprises a polarisation sensitive lens 181 (comprising liquid crystal 203, and manufactured as described above), a second lens 182, a quarter-wave (λ/4) plate 183, and a twisted nematic TN) liquid crystal cell 184.

The focal point of the objective system can be altered by using the bifocal nature of the liquid crystal lens 181.

In the off mode, the TN-cell acts to rotate the polarisation of incident radiation by 90°. For instance, as shown in FIG. 4A, when the TN-cell is off, then incident p-polarised radiation will be rotated by 90° to form s-polarised radiation.

The twisted nematic cell thus acts as a beam rotation means arranged to controllably alter the angle at which the polarised radiation beam is incident on the optical element 181. As an alternative, it will be appreciated that the optical element 181 could instead be rotated, with the polarised radiation beam remaining stationary.

It is assumed that, due to the particular orientation of the birefringent material within the optical element 181, when the s-polarised radiation is incident on the element 181, the radiation experiences the ordinary refractive index of the birefringent material. As, in this particular example, the ordinary refractive index is equal to the refractive index of the second portion of the optical element, the optical element 181 acts as an optically neutral element to s-polarised radiation. In other words, if the s-polarised radiation is a parallel beam incident upon the element 181, then it exits the element as a parallel beam.

After the optical element 181, the s-polarised beam is incident upon the quarter-wave plate, which acts to change the s-polarised beam to right hand circularly polarised light (RHC), which is focused on to the second information layer 4′. Upon reflection from the layer, the RHC light is converted to left hand circularly polarised light (LHC). The LHC light, upon being transmitted through the quarter-wave plate, is converted to p-polarised light. The p-polarised light then passes back through the optical element 181, and is changed to s-polarised light by the TN-cell 184.

As shown in FIG. 4A, this means that when p-polarised light enters the objective system 18, the light is incident upon the information layer 4′, and the reflective light leaves as s-polarised light from the objective system 18. Alternatively when s-polarised light enters the objective system 18, the light is incident upon the information layer 4 and the reflected light leaves the objective system as p-polarised. Consequently, if the beam splitter 13 shown in FIG. 3 is a polarising beam splitter, it is easy to ensure that no reflected light is directed back towards the light source 11, but almost all reflected is directed towards the detector 25 since most polarising beam splitters transmit p-polarised light and reflect s-polarised light.

In FIG. 4B, the same optical arrangement exists, but in this figure the TN-cell is on, e.g. by applying a sufficiently high voltage over the cell, such that the TN-cell does not change the polarisation of light passing through it. Consequently, p-polarised light is incident upon the optical element 181. The p-polarised light thus experiences a change in refractive index when passing from the second portion of the element 181 to the first portion of the element i.e. it experiences some focusing (convergence) due to the planoconvex birefringent lens that forms the first portion of the element 181.

The p-polarised light, which is now slightly converging, is then incident upon the quarter-wave plate 183. The quarter-wave plate acts to change the p-polarised light to LHC light, which is further focused by the lens 182 so as to be incident upon the first information layer 4. Upon reflection from the first information layer 4, the LHC light turns into RHC light. The RHC light, as it passes through the quarter-wave plate 183, is then changed to s-polarised light, which subsequently passes back through the optical element 181 and the TN-cell 184.

Thus, as shown in FIGS. 4A and 4B, an optical element may be provided in accordance with an embodiment of the present invention in a scanning device. The element 181 may function as a neutral optical component (as shown in FIG. 4A), or as a focusing element (as shown in FIG. 4B). Such an element, as it is optically neutral, emits relatively easy beam shaping within the scanning device.

It will be appreciated that the above embodiments are described by way of example only, and that various alternatives will be apparent to the skilled person.

The mould used in the manufacturing process may be formed of any material, including rigid materials such as glass.

Further, the shaped surface of the mould may be dimensioned so as to allow for any change in shape or volume of the liquid crystal material during the method. For instance, typically liquid crystal monomers shrink slightly upon polymerisation, due to double bonds within the liquid crystal being reformed as single bonds. By appropriately making the optical component shaped defined by the substrate and the mould slightly oversize, an appropriately sized and shaped optical component can be produced.

Whilst the substrates have been seen in this particular example as comprising a single sheet of glass, with two flat, substantially parallel sides, it will be appreciated that the substrates can in fact be any desired shape.

An extra adhesion layer may be applied to the mould and/or substrate (prior to deposition of the bonding layer onto the substrate and the orientation layer to the mould), so as to make sure that the applied layers are well attached to the mould and the substrate. For instance, organosilanes may be used to provide this adhesion layer. For the substrate an organosilane comprising a methacrylate group may be used and for the mould an organosilane comprising an amine end group may be used.

It will be appreciated that the above described optical components are described by way of example only. An optical component (or indeed, an optical element formed according to the present invention i.e. a portion of an optical component) could be formed with different properties to that described above.

For instance, in the above embodiments, it is assumed that the refractive index nₛ of the second portion of the component 620 is equal to nₒ. However, it will be appreciated that in fact any value of nₛ could be used, provided either nₑ≧nₛ≧nₒ or nₑ≦nₛ≦nₒ. For instance, an optical component could be formed with nₛ=nₑ.

Alternatively, nₛ could be any fixed, predetermined value between nₒ and nₑ. In such an instance, the optical element could be envisaged as having three separate modes of operation, depending upon the refractive index n_{θ} experienced by the polarised electromagnetic radiation beam as it passes through the birefringent material at an angle θ. The three modes will thus correspond to (I) n_{θ}<nₛ, (II) when n_{θ}=nₛ, and (III) when n_{θ}>nₛ. In each instance, the effect (power) of the curved interface within the optical element on the radiation will vary depending upon the differences between nₛ and n_{θ}.

Equally, whilst in the above embodiments the optical component has been described as having a curved interface between the two materials, it will be appreciated that the interface could in fact be of any shape that provides an optical function. For instance, the interface could be a step structure or a grating structure. In such instances, the optical functions of the components can still be switched on and off by setting the incident polarisation such that it leads to a substantially equal refractive index match between the two adjacent materials.

Whilst specific examples of materials suitable for forming the optical component have been described, and particular manufacturing steps, these are again provided by way of example only.

Equally, in the above embodiment it has been assumed that the second portion 620 of the optical element has a uniform refractive index nₛ, which is not polarisation dependent. However, it will be appreciated that in fact the second portion 620 could be formed of a birefringent material, as long as the criteria is satisfied that at a particular angle of incidence, the refractive index of the second portion 620 is equal to the refractive index of the first portion 610.

In the preferred embodiment, it is assumed that the outer surfaces of the optical element (i.e. the surfaces upon which the light enters and exits the element) are two flat, parallel surfaces. However, these surfaces could in fact be any desired shape, including concave or convex.

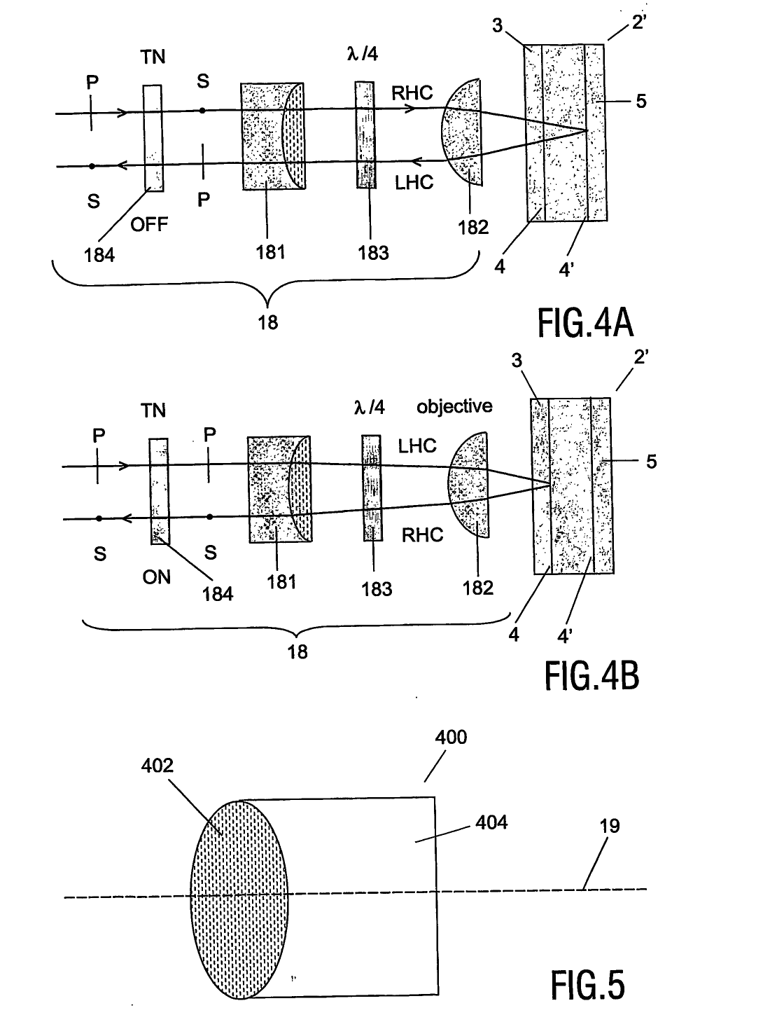

For instance, FIG. 5 illustrates an optical element 400 in accordance with a further embodiment of the present invention. In this embodiment, the optical element comprises a first portion 402 formed of a birefringent material, and a second portion 404 formed of a material having a refractive index equal to the extraordinary refractive index of the birefringent material. However, in this particular embodiment, the birefringent material is formed as a convex lens, rather than a planoconvex lens. As previously, the second portion of the optical element in this instance is formed as a planoconcave lens mated with one surface of the convex lens portion.

In all of the above embodiments of the optical component, the shaped interface between the two materials of the component can, for an appropriate angle of incidence polarised radiation, be optically neutral. This allows the optical element to be used in a number of novel and interesting ways.

1. An optical scanning device for scanning an information layer of an optical record carrier, the device comprising a radiation source for generating a radiation beam and an objective system for converging the radiation beam on the information layer, wherein the device includes an optical element comprising at least two adjacent materials with a shaped interface between the materials, at least the first of the materials being birefringent, the second material having a refractive index substantially equal to the refractive index of the birefringent material at a predetermined angle.

2. A device as claimed in claim 1, wherein the radiation source is arranged to generate a polarised radiation beam, the optical scanning device further comprising beam rotation means arranged to controllably alter the angle at which the polarised radiation beam is incident on the optical element.

3. A device as claimed in claim 2, wherein said beam rotation means is arranged to rotate the element.

4. A device as claimed in claim 2, wherein said beam rotation means is arranged to alter the polarisation angle of the polarised radiation beam.

5. A device as claimed in claim 1, wherein said second material is birefringent.

6. A device as claimed in claim 1, wherein the second material has a refractive index nₛ and the birefringent material has an ordinary refractive index nₒ and an extraordinary refractive index nₑ, wherein nₑ≧nₛ≧nₒ or nₑ≦nₛ≦nₒ.

7. A device as claimed in claim 1, wherein at least one of the first material and the second material is shaped as a lens.

8. A device as claimed in claim 1, wherein at least of said first material and said second material is shaped as at least one of a planoconcave lens and a planoconvex lens.

9. A device as claimed in claim 1, wherein one of the two materials is shaped as a planoconvex lens and the other of the two materials is shaped as a mating planoconcave lens.

10. An optical component comprising at least two adjacent materials with a curved interface between the materials, at least the first of the materials being birefringent the second material having a refractive index substantially equal to the refractive index of the birefringent material at a predetermined angle.

11. An optical element as claimed in claim 10, wherein said interface is curved.

12. An optical component as claimed in claim 10, wherein said first material comprises a polymerised anisotropically oriented liquid crystal.

13. An optical component as claimed in claim 10, wherein at least one of the outer surfaces of the optical element is planar.

14. A method of manufacturing an optical scanning device for scanning an information layer of an optical record carrier, the information layer being covered by a transparent layer of thickness t_{d} and refractive index n_{d}, the method comprising the steps of:
providing a radiation source for generating a radiation beam;
providing an optical element, the optical element comprising at least two adjacent materials with a shaped interface between the materials, at least the first of the materials being birefringent, the second material having a refractive index substantially equal to the refractive index of the birefringent material at a predetermined angle.

15. A method of manufacturing an optical component, the method comprising:
providing at least two adjacent materials with a shaped interface between the materials, at least the first material being birefringent and the second material having a refractive index substantially equal to one of the refractive indices of the birefringent material at a predetermined angle.

16. A method as claimed in claim 15, the method comprising:
placing a material between a substrate and a mould, the mould having a shaped surface, at least a portion of the shaped surface having an alignment layer formed thereon, and the substrate having a first surface on which is formed a bonding layer;
bringing the mould and the substrate together so as to sandwich the material between the first surface of the substrate and the shaped surface of the mould;
polymerising the material so as to form said first material;
adhering the material to the bonding layer;
removing the substrate with the adhered polymerised material from the mould;
covering the shaped surface of the polymerised first material with a polymerisable further material; and
polymerising the further material so as to form the second material.
